(19) United States
(12) Patent Application Publication
(10) Pub. No.: US 2020/0133145 A1
(43) Pub. Date: Apr. 30, 2020

(54) ELECTROPHOTOGRAPHIC PHOTOCONDUCTOR, PROCESS CARTRIDGE, AND ELECTROPHOTOGRAPHIC APPARATUS

(71) Applicant: CANON KABUSHIKI KAISHA, Tokyo (JP)

(72) Inventors: Kan Tanabe, Matsudo-shi (JP); Tatsuya Ikezue, Toride-shi (JP); Kumiko Takizawa, Saitama-shi (JP); Haruhiko Mitsuda, Nagareyama-shi (JP); Ikuyo Kuroiwa, Tokyo (JP); Takanori Ueno, Nagareyama-shi (JP); Tsuyoshi Shimada, Kashiwa-shi (JP)

(21) Appl. No.: 16/657,875

(22) Filed: Oct. 18, 2019

(30) Foreign Application Priority Data
Oct. 25, 2018 (JP) 2018-201213
Sep. 30, 2019 (JP) 2019-180287

(51) Int. Cl. G03G 5/047; G03G 5/05; G03G 5/07

(52) U.S. Cl. CPC G03G 5/047; G03G 5/0546; G03G 5/075; G03G 5/0578

(57) ABSTRACT

An electrophotographic photoconductor includes, in sequence, a support, an undercoat layer, a charge generation layer containing a charge generation material and a first binder resin, and a charge transport layer containing a charge transport material and a second binder resin. The charge generation material in the charge generation layer is chlorogallium phthalocyanine having diffraction peaks at Bragg angles (2θ±0.2°) of 7.4°, 16.6°, 25.5°, and 28.3° in an X-ray diffraction pattern obtained by using Cu K-α radiation. The undercoat layer contains strontium titanate particles and a third binder resin.

### BACKGROUND OF THE INVENTION

### Field of the Invention

The present disclosure relates to an electrophotographic photoconductor, and a process cartridge and an electrophotographic apparatus that include the electrophotographic photoconductor.

### Description of the Related Art

In recent years, organic electrophotographic photoconductors (hereinafter may also be referred to as “electrophotographic photoconductors” or “photoconductors”) have become increasingly high sensitive in order to comply with improved printing speed of electrophotographic apparatuses. Since the sensitivity of a photoconductor is heavily dependent on characteristics of a charge generation material, development of novel charge generation materials having better characteristics has been actively pursued.

One of charge generation materials is phthalocyanine pigments, and various compounds, such as metal-free phthalocyanine, titanyl phthalocyanine, and gallium phthalocyanine, have been developed.

Since titanyl phthalocyanine and gallium phthalocyanine have excellent characteristics, they are widely used as the charge generation materials of photoconductors currently available in the market.

Japanese Patent Laid-Open No. 05-98181 discloses a chlorogallium phthalocyanine pigment having diffraction peaks at least at Bragg angles (2θ±0.2°) of 7.4°, 16.6°, 25.5°, and 28.3° in an X-ray diffraction pattern obtained by using Cu K-α radiation, and a photoconductor that uses the chlorogallium phthalocyanine pigment.

Meanwhile, in order to suppress charging failure caused by leakage etc., an undercoat layer is sometimes formed between a support and a photosensitive layer of an electrophotographic photoconductor. There are various structures known as the structure of the undercoat layer. In particular, an undercoat layer obtained by dispersing metal oxide particles in a binder resin is widely used. In Examples 1-8 in Japanese Patent Laid-Open No. 2002-341569, there is disclosed an undercoat layer that contains zinc oxide fine particles, a silicone oil, and a binder resin, and a photoconductor having a charge generation layer containing, as a charge generation material, a chlorogallium phthalocyanine pigment having diffraction peaks at least at Bragg angles (2θ±0.2°) of 7.4°, 16.6°, 25.5°, and 28.3° in an X-ray diffraction pattern obtained by using Cu K-α radiation.

### SUMMARY OF THE INVENTION

One aspect of the present disclosure is directed to providing an electrophotographic photoconductor in which changes in charging potential are suppressed even when the electrophotographic photoconductor is repeatedly used in a low-humidity environment for a long term, and a process cartridge and an electrophotographic apparatus that include the electrophotographic photoconductor.

According to one aspect of the present disclosure, there is provided an electrophotographic photoconductor that includes, in sequence a support, an undercoat layer, a charge generation layer containing a charge generation material and a first binder resin, and a charge transport layer containing a charge transport material and a second binder resin, wherein the charge generation material is chlorogallium phthalocyanine having diffraction peaks at Bragg angles (2θ±0.2°) of 7.4°, 16.6°, 25.5°, and 28.3° in an X-ray diffraction pattern obtained by using Cu K-α radiation, and the undercoat layer contains strontium titanate particles and a third binder resin.

Further features of the present disclosure will become apparent from the following description of exemplary embodiments with reference to the attached drawings.

### BRIEF DESCRIPTION OF THE DRAWINGS

FIG. 1 is a diagram illustrating one example of a layer structure of an electrophotographic photoconductor of the present disclosure.

FIG. 2 is a diagram illustrating one example of an electrophotographic apparatus equipped with a process cartridge having an electrophotographic photoconductor of the present disclosure.

FIG. 3 is a diagram illustrating one example of a polisher using a polishing sheet.

FIG. 4A is a top view of a mold used in Production Example of an electrophotographic photoconductor.

FIG. 4B is a cross-sectional view of a protrusion on the mold illustrated in FIG. 4A taken along line IVB-IVB.

FIG. 4C is a cross-sectional view of a protrusion in the mold illustrated in FIG. 4A taken along line IVC-IVC.

FIG. 5 is a diagram illustrating one example of a pressure-contact profile transfer processing apparatus for forming recesses on a peripheral surface of an electrophotographic photoconductor.

### DESCRIPTION OF THE EMBODIMENTS

According to the studies conducted by the inventors of the present disclosure, when the electrophotographic photoconductors described in the aforementioned patent documents are repeatedly used in a low-humidity environment for a long term, the charging potential may gradually and significantly deviate from the value at the start of the use, and improvements are desirable from the viewpoint of the charging potential stability.

The present disclosure will now be described in detail through preferable embodiments.

An electrophotographic photoconductor of the present disclosure includes, in sequence, a support, an undercoat layer, a charge generation layer containing a charge generation material and a first binder resin, and a charge transport layer that contains a charge transport material and a second binder resin. The undercoat layer contains strontium titanate particles and a third binder resin, and the charge generation layer contains, as a charge generation material, a chlorogallium phthalocyanine pigment having diffraction peaks at Bragg angles (2θ±0.2°) of 7.4°, 16.6°, 25.5°, and 28.3° in an X-ray diffraction pattern obtained by using Cu K-α radiation.

The inventors of the present disclosure have conducted extensive studies and found that, by forming a charge generation layer containing, as a charge generation material, the aforementioned chlorogallium phthalocyanine pigment on a surface of an undercoat layer containing strontium titanate particles, changes in charging potential are suppressed even after a long-term repeated use in a low-humidity environment.

The details of the mechanism of suppressing changes in charging potential are not exactly clear, but the inventors of the present disclosure have made the following assumption. When pairing of hole and electron is generated in the chlorogallium phthalocyanine pigment by charging and exposure, electron migrate from the pigment side to the undercoat layer side. Presumably, when electrons remain at the interface between the charge generation layer and the undercoat layer, the charging potential in the next charging process is affected, and charging potential fluctuates. The electron migration is considered to take place mainly at the part where the chlorogallium phthalocyanine pigment and strontium titanate particles come into contact with each other. The assumption of the inventors of the present disclosure is that the interaction at the contacting points affects to the electron migration, and thus residual electrons are suppressed and thus charging potential fluctuation is suppressed.

The number average particle diameter of the primary particles of the strontium titanate particles of the present disclosure is not particularly limited, but, from the viewpoint of the electrical characteristics, is preferably 10 nm or more and 150 nm or less and more preferably 10 nm or more and 95 nm or less.

The strontium titanate particles of the present disclosure may be surface-treated with a surface treatment agent. And a silane coupling agent is a preferable surface treatment agent. In particular, from the viewpoint of the electrical characteristics, the silane coupling agent can have at least one functional group selected from the group consisting of an alkyl group, an amino group, and a halogen group.

### Electrophotographic Photoconductor

The electrophotographic photoconductor of the present disclosure includes an undercoat layer, a charge generation layer, and a charge transport layer.

One example of the method for producing the electrophotographic photoconductor of the present disclosure is a method that involves preparing coating solutions of respective layers described below, applying the coating solutions in the desired order of the layers, and drying the applied coating solutions. Here, examples of the method for applying the coating solutions include dip coating, spray coating, inkjet coating, roll coating, die coating, blade coating, curtain coating, wire bar coating, and ring coating methods. Among these, dip coating can be employed from the viewpoints of efficiency and productivity. The respective layers are described below.

### Support

In the present disclosure, the electrophotographic photoconductor includes a support. In the present disclosure, the support can be an electrically conductive support having electroconductivity. Examples of the shape of the support include a cylindrical shape, a belt shape, and a sheet shape. In particular, a cylindrical support is preferable. The surface of the support may be subjected to an electrochemical treatment such as anodizing, blasting, machining, or the like.

The material for the support can be a metal, a resin, glass, or the like.

Examples of the metal include aluminum, iron, nickel, copper, gold, stainless steel, and alloys thereof. In particular, an aluminum support formed of aluminum is preferable.

The resin or glass may be treated to have electroconductivity, for example, by mixing a conductive material to the resin or glass or coating the resin or glass with a conductive material.

### Conductive Layer

In the present disclosure, a conductive layer may be formed between the support and the undercoat layer. Scratches and unevenness of the support surface can be covered and the reflection of light at the support surface can be controlled by forming the conductive layer.

The conductive layer can contain conductive particles and a resin.

Examples of the material for the conductive particles include metal oxide, metal, and carbon black.

Examples of the metal oxide include zinc oxide, aluminum oxide, indium oxide, silicon oxide, zirconium oxide, tin oxide, titanium oxide, magnesium oxide, antimony oxide, and bismuth oxide. Examples of the metal include aluminum, nickel, iron, nichrome, copper, zinc, and silver.

Among these, a metal oxide can be used as the conductive particles, and, in particular, titanium oxide, tin oxide, or zinc oxide is preferably used.

When metal oxide is used as the conductive particles, the surface of the metal oxide may be treated with a silane coupling agent or the like, or the metal oxide may be doped with an element such as phosphorus or aluminum or an oxide thereof.

The conductive particles may have a multilayer structure that has a core particle and a cover layer that covers the core particle. Examples of the core particle include titanium oxide, barium sulfate, and zinc oxide. Examples of the cover layer include metal oxide such as tin oxide.

When metal oxide is used as the conductive particles, the volume average particle diameter is preferably 1 nm or more and 500 nm or less and more preferably 3 nm or more and 400 nm or less.

Examples of the resin include polyester resins, polycarbonate resins, polyvinyl acetal resins, acrylic resins, silicone resins, epoxy resins, melamine resins, polyurethane resins, phenolic resins, and alkyd resins.

The conductive layer may further contain a silicone oil, resin particles, and a masking agent such as titanium oxide.

The average thickness of the conductive layer is preferably 1 μm or more and 50 μm or less and more preferably 3 μm or more and 40 μm or less.

The conductive layer can be formed by preparing a conductive layer coating solution that contains the aforementioned materials and a solvent, forming a coating film therefrom, and drying the coating film. Examples of the solvent used in the coating solution include alcohol solvents, sulfoxide solvents, ketone solvents, ether solvents, ester solvents, and aromatic hydrocarbon solvents. Examples of the method for dispersing conductive particles in the conductive layer coating solution include methods that use a paint shaker, a sand mill, a ball mill, and a liquid collision-type high-speed disperser.

### Undercoat Layer

In the present disclosure, the electrophotographic photoconductor includes an undercoat layer on the support (or the conductive layer).

The undercoat layer in the electrophotographic photoconductor of the present disclosure contains strontium titanate particles and a binder resin, as described above.

In the present disclosure, the strontium titanate particle content relative to the total mass of the undercoat layer can be 50 mass % or more and 90 mass % or less.

If the content is less than 50 mass %, the contacting points of the chlorogallium phthalocyanine pigment and strontium titanate particles is not secure enough and the electron migration efficiency may be degraded. In contrast, at a content exceeding 90 mass %, the binder resin content in the undercoat layer decreases relatively, and thus the surface roughness of the formed undercoat layer tends to increase. When the surface roughness of the undercoat layer is excessively large, flatness and smoothness of the charge generation layer applied to the surface of the undercoat layer may be degraded, and the halftone image roughness may occur due to minute film thickness unevenness of the charge generation layer. Thus, in order to suppress halftone image roughness, the strontium titanate particle content in the undercoat layer can be 90 mass % or less.

Examples of the binder resin include polyester resins, polycarbonate resins, polyvinyl acetal resins, acrylic resins, epoxy resins, melamine resins, polyurethane resins, phenolic resins, polyvinyl phenol resins, alkyd resins, polyvinyl alcohol resins, polyethylene oxide resins, polypropylene oxide resins, polyamide resins, polyamic acid resins, polyimide resins, polyamideimide resins, and cellulose resins.

The binder resin may be formed by polymerizing a composition that contains a monomer having a polymerizable functional group. Examples of the polymerizable functional group of the monomer having a polymerizable functional group include an isocyanate group, a blocked isocyanate group, a methylol group, an alkylated methylol group, an epoxy group, a metal alkoxide group, a hydroxyl group, an amino group, a carboxyl group, a thiol group, a carboxylic anhydride group, and a carbon-carbon double bond group.

In order to improve electrical characteristics, the undercoat layer of the present disclosure may further contain an electron-accepting material, an electron transport material, metal oxide, metal, a conductive polymer, or the like.

Examples of the electron-accepting material include quinone compounds, anthraquinone compounds, phthalocyanine compounds, porphyrin compounds, triphenylmethane compounds, fluorenylidene malononitrile compounds, and benzalmalononitrile compounds.

Examples of the electron transport material include quinone compounds, imide compounds, benzimidazole compounds, cyclopentadienylidene compounds, fluorenone compounds, xanthone compounds, benzophenone compounds, cyanovinyl compounds, halogenated aryl compounds, silole compounds, and boron-containing compounds. An electron transport material having a polymerizable functional group may be used as the electron transport material, and an undercoat layer may be formed as a cured film obtained by copolymerization between the electron transport material and the monomer having a polymerizable functional group described above.

Examples of the compounds having an electron accepting property or electron transportability are described below.

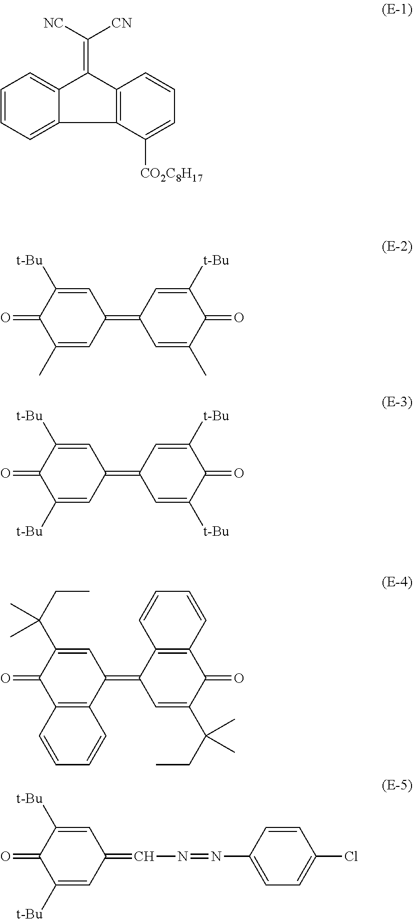

Examples of the metal oxide include indium tin oxide, tin oxide, indium oxide, titanium oxide, zinc oxide, aluminum oxide, and silicon dioxide. Examples of the metal include gold, silver, and aluminum.

From the viewpoint of the electrical characteristics, the undercoat layer of the present disclosure can contain at least one compound selected from the group consisting of compounds represented by general formula (1) and general formula (2). These compounds may be used alone or in combination.

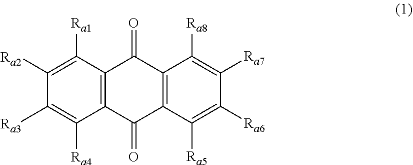

In general formula (1), Rₐ₁ to Rₐ₈ each independently represent a hydrogen atom, a hydroxy group, a halogen atom, an alkyl group, an alkoxy group, a phenyl group, or an amino group.

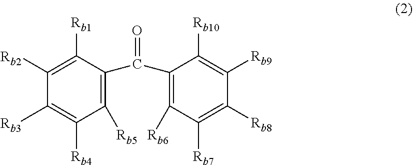

In general formula (2), R_{b1} to R_{b10} each independently represent a hydrogen atom, a hydroxy group, a halogen atom, an alkyl group, an alkoxy group, a phenyl group, or an amino group.)

The undercoat layer of the present disclosure may further contain organic resin particles and a leveling agent. Examples of the organic resin particles include hydrophobic organic resin particles such as silicone particles and hydrophilic organic resin particles such as crosslinked polymethacrylate resin (PMMA) particles.

The average thickness of the undercoat layer of the present disclosure is preferably 0.1 μm or more and 50 μm or less and more preferably 0.2 μm or more and 40 μm or less.

The undercoat layer of the present disclosure can be formed by preparing an undercoat layer coating solution that contains the aforementioned materials and a solvent, forming a coating film therefrom, and drying and/or curing the coating film. Examples of the solvent used in the coating solution include an alcohol solvent, a ketone solvent, an ether solvent, an ester solvent, and an aromatic hydrocarbon solvent.

### Photosensitive Layer

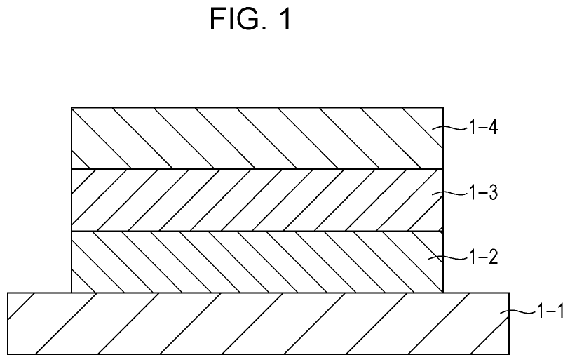

An electrophotographic photoconductor of the present disclosure is a multilayer photoconductor that includes a charge generation layer containing a charge generation material and a charge transport layer containing a charge transport material, the charge generation layer and the charge transport layer being stacked on the undercoat layer. FIG. 1 illustrates one example of an overall structure of the electrophotographic photoconductor of the present disclosure. In FIG. 1, reference sign 1-1 denotes a support, 1-2 denotes an undercoat layer, 1-3 denotes a charge generation layer, and 1-4 denotes a charge transport layer.

### Charge Generation Layer

The charge generation layer can contain a charge generation material and a resin.

In the present disclosure, the charge generation layer contains, as a charge generation material, a chlorogallium phthalocyanine pigment having diffraction peaks at Bragg angles (2θ±0.2°) of 7.4°, 16.6°, 25.5°, and 28.3° in an X-ray diffraction pattern obtained by using Cu K-α radiation.

A charge generation material other than the aforementioned chlorogallium phthalocyanine pigment can be additionally used as the charge generation material. Examples of this charge generation material include an azo pigment, a perylene pigment, a polycyclic quinone pigment, an indigo pigment, and a phthalocyanine pigment. Among these, an azo pigment and a phthalocyanine pigment are preferable. Of phthalocyanine pigments, a hydroxygallium phthalocyanine pigment is particularly preferable, and in particular, a V-type hydroxygallium phthalocyanine pigment having diffraction peaks at Bragg angles (2θ±0.2°) of 7.5°, 9.9°, 12.5°, 16.3°, 18.6°, 25.1°, and 28.3° in an X-ray diffraction pattern obtained by using Cu K-α radiation is preferable for its high sensitivity. The X-ray diffraction measurement can be performed on the chlorogallium phthalocyanine pigment and the hydroxygallium phthalocyanine pigment by the following method, for example.

### Example of Powder X-Ray Diffraction Measurement

Measurement instrument: X-ray diffractometer RINT-TTR II produced by Rigaku Corporation, X-ray tube: Cu, tube voltage: 50 kV, tube current: 300 mA, scan method: 2θ/θ scan, scan speed: 4.0°/min, sampling interval: 0.02°, start angle (2θ): 5.0°, stop angle (2θ): 40.0°, attachment: standard sample holder, filter: not used, incident monochromator: used, counter monochromator: not used, divergence slit: open, divergence vertical limitation slit: 10.00 mm, scatter slit: open, receiving slit: open, counter: scintillation counter

The charge generation material content in the charge generation layer relative to the total mass of the charge generation layer is preferably 40 mass % or more and 85 mass % or less and more preferably 60 mass % or more and 80 mass % or less. At a content less than 40 mass %, the residual charge tends to increase during the use of the photoconductor although this depends on the type of the charge generation material and the charge transport material used. At a content exceeding 80 mass %, the binder resin content decreases relatively, and thus minute film thickness unevenness attributable to the surface roughness of the undercoat layer readily occurs during formation of the charge generation layer by application. The minute film thickness unevenness of the charge generation layer may degrade the halftone image roughness.

In the present disclosure, the chlorogallium phthalocyanine content relative to the total mass of the charge generation layer can be 20 mass % or more and 80 mass % or less, preferably 30 mass % or more and 80 mass % or less. If the content is less than 20 mass %, the contacting points of the chlorogallium phthalocyanine pigment and the strontium titanium particles in the undercoat layer are not secure enough, and the electron migration efficiency may be degraded. The issues that can arise when the content exceeds 80 mass % are as described above.

The sensitivity of a photoconductor can be adjusted by changing the total charge generation material content in the charge generation layer or the thickness of the charge generation layer. The sensitivity can also be adjusted by mixing charge generation materials having different charge generation efficiency and changing the mixing ratio of these charge generation materials. The latter approach is advantageous in that the coatability of the charge generation layer coating solution can be improved and that the adverse effect on the film-forming property of the charge generation layer can be suppressed. In the present disclosure, when the chlorogallium phthalocyanine pigment and the hydroxygallium phthalocyanine pigment having a higher charge generation efficiency are used in combination as a mixture, the sensitivity can be adjusted by changing the mixing ratio of these two pigments.

Examples of the resin include polyester resins, polycarbonate resins, polyvinyl acetal resins, polyvinyl butyral resins, acrylic resins, silicone resins, epoxy resins, melamine resins, polyurethane resins, phenolic resins, polyvinyl alcohol resins, cellulose resins, polystyrene resins, polyvinyl acetate resins, and polyvinyl chloride resins. Among these, polyvinyl butyral resins are more preferable.

The charge generation layer may further contain additives such as an antioxidant and an ultraviolet absorber. Specific examples thereof include a hindered phenol compound, a hindered amine compound, a sulfur compound, a phosphorus compound, and a benzophenone compound.

The average thickness of the charge generation layer is preferably 0.05 μm or more and 1 μm or less and more preferably 0.1 μm or more and 0.3 μm or less.

The charge generation layer can be formed by preparing a charge generation layer coating solution that contains the aforementioned materials and a solvent, forming a coating film therefrom, and drying the coating film. Examples of the solvent used in the coating solution include an alcohol solvent, a sulfoxide solvent, a ketone solvent, an ether solvent, an ester solvent, and an aromatic hydrocarbon solvent.

### Charge Transport Layer

The charge transport layer can contain a charge transport material and a resin.

Examples of the charge transport material include polycyclic aromatic compounds, heterocyclic compounds, hydrazone compounds, styryl compounds, enamine compounds, benzidine compounds, triarylamine compounds, and resins having groups derived from these materials. Among these, triarylamine compounds and benzidine compounds are preferable.

The charge transport material content in the charge transport layer relative to the total mass of the charge transport layer is preferably 25 mass % or more and 70 mass % or less and more preferably 30 mass % or more and 55 mass % or less.

Examples of the resin include polyester resins, polycarbonate resins, acrylic resins, and polystyrene resins. Among these, polycarbonate resins and polyester resins are preferable. As the polyester resins, polyarylate resins are particularly preferable.

The content ratio (mass ratio) of the charge transport material to the resin is preferably 4:10 to 20:10 and more preferably 5:10 to 12:10.

The charge transport layer may further contain additives such as an antioxidant, an ultraviolet absorber, a plasticizer, a leveling agent, a slidability-imparting agent, and a wear resistance improver. Specific examples thereof include hindered phenol compounds, hindered amine compounds, sulfur compounds, phosphorus compounds, benzophenone compounds, siloxane-modified resins, silicone oil, fluororesin particles, polystyrene resin particles, polyethylene resin particles, silica particles, alumina particles, and boron nitride particles.

The average thickness of the charge transport layer is preferably 5 μm or more and 50 μm or less, more preferably 8 μm or more and 40 μm or less, and yet more preferably 10 μm or more and 30 μm or less.

The charge transport layer can be formed by preparing a charge transport layer coating solution that contains the aforementioned materials and a solvent, forming a coating film therefrom, and drying the coating film. Examples of the solvent used in the coating solution include an alcohol solvent, a ketone solvent, an ether solvent, an ester solvent, and an aromatic hydrocarbon solvent. Among these solvents, an ether solvent or an aromatic hydrocarbon solvent is preferable.

### Protective Layer

In the present disclosure, a protective layer may be formed on the photosensitive layer. Forming the protective layer can improve endurance. The protective layer can contain conductive particles and/or a charge transport material, and a resin. Examples of the conductive particles include particles of metal oxides such as titanium oxide, zinc oxide, tin oxide, and indium oxide.

Examples of the charge transport material include polycyclic aromatic compounds, heterocyclic compounds, hydrazone compounds, styryl compounds, enamine compounds, benzidine compounds, triarylamine compounds, and resins having groups derived from these materials. Among these, triarylamine compounds and benzidine compounds are preferable.

Examples of the resin include polyester resins, acrylic resins, phenoxy resins, polycarbonate resins, polystyrene resins, phenolic resins, melamine resins, and epoxy resins. Among these, polycarbonate resins, polyester resins, and acrylic resins are preferable.

The protective layer may be formed as a cured film formed by polymerizing a composition that contains a monomer having a polymerizable functional group. Examples of the reaction that occurs during this process include a thermal polymerization reaction, a photopolymerization reaction, and a radiation polymerization reaction. Examples of the polymerizable functional group contained in the monomer having a polymerizable functional group include an acryl group and a methacryl group. A material having a charge transport property may be used as the monomer having a polymerizable functional group.

The protective layer may further contain additives such as an antioxidant, an ultraviolet absorber, a plasticizer, a leveling agent, a slidability-imparting agent, and a wear resistance improver. Specific examples thereof include hindered phenol compounds, hindered amine compounds, sulfur compounds, phosphorus compounds, benzophenone compounds, siloxane-modified resins, silicone oil, fluororesin particles, polystyrene resin particles, polyethylene resin particles, silica particles, alumina particles, and boron nitride particles.

The average thickness of the protective layer is preferably 0.5 μm or more and 10 μm or less and more preferably 1 μm or more and 7 μm or less.

The protective layer can be formed by preparing a protective layer coating solution that contains the aforementioned materials and a solvent, forming a coating film therefrom on the photosensitive layer, and drying and/or curing the coating film. Examples of the solvent used in the coating solution include an alcohol solvent, a ketone solvent, an ether solvent, a sulfoxide solvent, an ester solvent, and an aromatic hydrocarbon solvent.

### Surface Processing of Electrophotographic Photoconductor

The surface layer of the electrophotographic photoconductor of the present disclosure can be roughened by polishing or can have recesses and protrusions formed thereon so that the behavior of a cleaning unit (cleaning blade) that contacts the electrophotographic photoconductor is further stabilized.

When the surface layer of the electrophotographic photoconductor is to be roughened by polishing, a polishing tool can be brought into contact with the electrophotographic photoconductor and one or both of the electrophotographic photoconductor and the polishing tool may be moved relative to each other to polish the surface of the electrophotographic photoconductor and impart roughness. An example of the polishing tool is a polishing member that includes a substrate and a layer disposed on the substrate and containing abrasive grains dispersed in a binder resin.

When recesses are to be formed, a mold having protrusions corresponding to the recesses is brought into pressure-contact with the surface of the electrophotographic photoconductor to carry out profile transfer, as a result of which recesses can be formed on the surface of the electrophotographic photoconductor.

When protrusions are to be formed, a mold having recesses corresponding to the protrusions is brought into pressure-contact with the surface of the electrophotographic photoconductor to carry out profile transfer, as a result of which protrusions can be formed on the surface of the electrophotographic photoconductor.

### Polishing Tool Used in Mechanical Polishing

A known device can be used for mechanical polishing. Typically, the surface of the electrophotographic photoconductor is polished by bringing a polishing tool in to contact with the electrophotographic photoconductor and moving one or both of the electrophotographic photoconductor and the polishing tool relative to each other. The polishing tool is a polishing member that includes a substrate and a layer disposed on the substrate and containing abrasive grains dispersed in a binder resin. Examples of the abrasive grains include particles of aluminum oxide, chromium oxide, diamond, iron oxide, cerium oxide, corundum, silica stone, silicon nitride, boron nitride, molybdenum carbide, silicon carbide, tungsten carbide, titanium carbide, and silicon oxide. The grain diameter of the abrasive grains is preferably 0.01 μm or more and 50 μm or less and more preferably 1 μm or more and 15 μm or less. When the grain diameter of the abrasive grains is excessively small, the polishing power is decreased, and it becomes difficult to increase the F/C ratio at the outermost surface of the electrophotographic photoconductor. One type of abrasive grains or a mixture of two or more types of abrasive grains can be used. When two or more types of abrasive grains are mixed, the material and/or the grain diameter may be the same or different.

Examples of the binder resin in which the abrasive grains used in the polishing tool are dispersed include known thermoplastic resins, thermosetting resins, reactive resins, electron beam curable resins, ultraviolet curable resins, visible light curable resins, and antifungal resins. Examples of the thermoplastic resins include vinyl chloride resins, polyamide resins, polyester resins, polycarbonate resins, amino resins, styrene-butadiene copolymers, urethane elastomers, and polyamide-silicone resins. Examples of the thermosetting resins include phenolic resins, phenoxy resins, epoxy resins, polyurethane resins, polyester resins, silicone resins, melamine resins, and alkyd resins. An isocyanate-based curing agent may be added to a thermoplastic resin.

In the polishing tool, the thickness of the layer containing abrasive grains dispersed in a binder resin can be 1 μm or more to 100 μm or less. When the thickness is excessively large, the film thickness unevenness readily occurs, and, the unevenness in film thickness of the subject to be polished (workpiece) becomes an issue. However, when the thickness is excessively small, abrasive grains easily fall off.

The shape of the substrate of the polishing tool is not particularly limited. In an embodiment of this example, a sheet-shaped substrate is used to efficiently polish the cylindrical electrophotographic photoconductor; however, the shape of the substrate may be any other shape. The substrate of the polishing tool (hereinafter, the polishing tool of this example may also be referred to as a “polishing sheet”) may be formed of any material. Examples of the material for the sheet-shaped substrate include paper, woven fabric, nonwoven fabric, and a plastic film.

The polishing tool can be obtained by applying, to a substrate, a coating solution obtained by mixing and dispersing the aforementioned abrasive grains, a binder resin, and a solvent that can dissolve the binder resin, and drying the applied coating solution.

### Polishing Apparatus

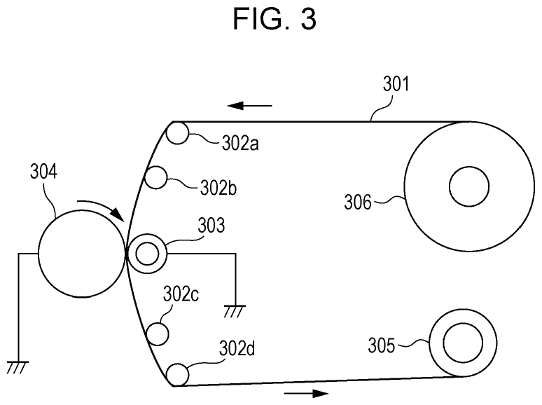

FIG. 3 illustrates one example of the polishing apparatus for the electrophotographic photoconductor of this example. FIG. 3 illustrates an apparatus that polishes the cylindrical electrophotographic photoconductor by using a polishing sheet. In FIG. 3, a polishing sheet 301 is wound around a hollow shaft 306, and a motor (not illustrated) is provided to the shaft 306 so that a tension acts on the polishing sheet 301 in a direction opposite to the direction in which the polishing sheet 301 is fed. The polishing sheet 301 is fed in the arrow direction, passes through a backup roller 303 via guide rollers 302a and 302b, and, after polishing, is taken up by a take-up unit 305 by a motor (not illustrated) via guide rollers 302c and 302d. Polishing involves having the polishing sheet 301 to constantly pressure-contact a workpiece (the electrophotographic photoconductor before polishing) 304. Since the polishing sheet 301 often has an insulation property, a part of the polishing sheet 301 that makes contact with the workpiece can be earthed or can be formed of a conductive material.

The feed speed of the polishing sheet 301 can be 10 mm/min or more and 1000 mm/min or less. When the feed amount is insufficient, the binder resin may attach to the surface of the polishing sheet 301 and as a result, deep scratches may be generated in the surface of the workpiece 304.

The workpiece 304 is positioned to face the backup roller 303 with the polishing sheet 301 therebetween. From the viewpoint of improving the evenness of the surface roughness of the workpiece 304, the backup roller 303 can be an elastic body. During this process, the workpiece 304 and the backup roller 303 are pressed against each other at a desired setting value for a particular amount of time with the polishing sheet 301 therebetween, and the surface of the workpiece 304 is polished. The rotation direction of the workpiece 304 may be the same as or opposite to the feed direction of the polishing sheet 301. In addition, the rotation direction may be changed during polishing.

The pressing pressure of the backup roller 303 against the workpiece 304 can be 0.005 N/m² or more and 15 N/m² or less although this depends on the hardness of the backup roller 303 and the polishing time.

The surface roughness of the electrophotographic photoconductor can be adjusted by appropriately selecting the feed speed of the polishing sheet 301, the pressing pressure of the backup roller 303, the type of the abrasive grains in the polishing sheet, the thickness of the binder resin of the polishing sheet, the thickness of the substrate, etc.

### Method for Forming Recesses on Peripheral Surface of Electrophotographic Photoconductor

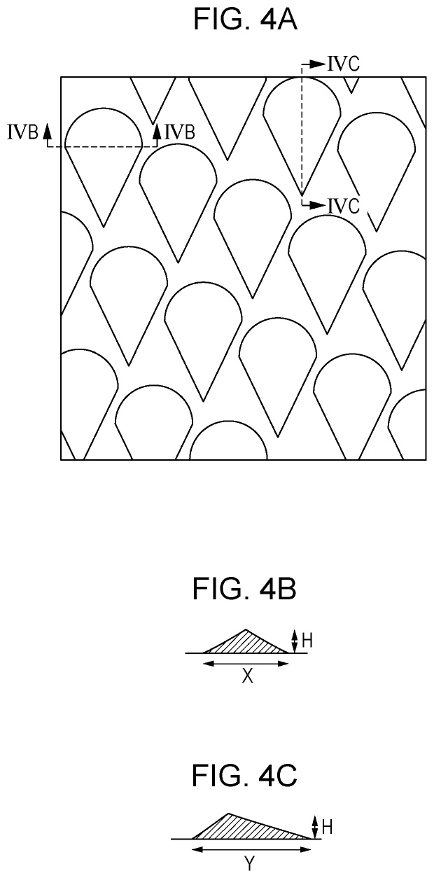

A mold having protrusions corresponding to the recesses to be formed is brought into pressure-contact with the peripheral surface of the electrophotographic photoconductor to carry out profile transfer, and, as a result, recesses can be formed on the surface of the electrophotographic photoconductor. FIGS. 4A to 4C are each a schematic diagram of a mold having protrusions. FIG. 4A is a schematic top view of the mold, and FIG. 4B is a schematic cross-sectional view of a protrusion of the mold taken in a direction of the axis of the electrophotographic photoconductor (cross-sectional view taken along line IVB-IVB in FIG. 4A). FIG. 4C is a schematic cross-sectional view of a protrusion of the mold taken in the circumferential direction of the electrophotographic photoconductor (cross-sectional view taken along line IVC-IVC in FIG. 4A).

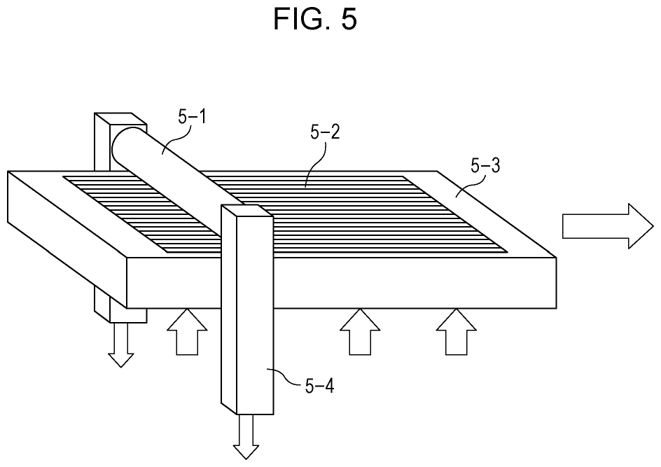

FIG. 5 illustrates one example of a pressure-contact profile transfer processing apparatus for forming recesses on a peripheral surface of an electrophotographic photoconductor. According to the pressure-contact profile transfer processing apparatus illustrated in FIG. 5, a mold 5-2 is continuously brought into contact with a peripheral surface of a workpiece, which is an electrophotographic photoconductor 5-1, while rotating the workpiece, to apply pressure. As a result, recesses and flat portions can be formed on the peripheral surface of the electrophotographic photoconductor 5-1.

Examples of the material for a pressing member 5-3 include metal, metal oxide, plastic, and glass. Among these, stainless steel (SUS) is preferable from the viewpoints of mechanical strength, accuracy of dimension, and endurance. The pressing member 5-3 has an upper surface onto which the mold 5-2 is placed. A support member (not illustrated) and a pressurizing system (not illustrated) disposed on the lower surface side cause the mold 5-2 to contact, at a particular pressure, the peripheral surface of the electrophotographic photoconductor 5-1 supported by a support member 5-4. Alternatively, the support member 5-4 may be pressed against the pressing member 5-3 at a particular pressure, or the support member 5-4 and the pressing member 5-3 may both be pressed against each other.

In the example illustrated in FIG. 5, the pressing member 5-3 is moved in a direction perpendicular to the axis direction of the electrophotographic photoconductor 5-1 in order to continuously process the peripheral surface of the electrophotographic photoconductor 5-1 while the electrophotographic photoconductor 5-1 is being driven or rotated. Furthermore, the peripheral surface of the electrophotographic photoconductor 5-1 can be continuously processed by fixing the pressing member 5-3 and moving the support member 5-4 in a direction perpendicular to the axis direction of the electrophotographic photoconductor 5-1 or by moving both the support member 5-4 and the pressing member 5-3.

From the viewpoint of efficiently carrying out the profile transfer, the mold 5-2 and the electrophotographic photoconductor 5-1 can be heated. Examples of the mold 5-2 include a metal or resin film having a finely processed surface, a silicon wafer having a surface patterned by using a resist, a resin film in which fine particles are dispersed, and a resin film having a fine surface profile and coated with metal.

From the viewpoint of making the pressure acting on the electrophotographic photoconductor 5-1 even, an elastic body can be disposed between the mold 5-2 and the pressing member 5-3.

The recesses, flat portions, and protrusions on the peripheral surface of the electrophotographic photoconductor can be observed with a microscope such as a laser microscope, an optical microscope, an electron microscope, or an interatomic force microscope.

### Process Cartridge and Electrophotographic Apparatus

A process cartridge of the present disclosure is detachably attachable to an electrophotographic apparatus main body, and integrates and supports the aforementioned electrophotographic photoconductor and at least one unit selected from the group consisting of a charging unit, a developing unit, a transfer unit, and a cleaning unit.

An electrophotographic apparatus of the present disclosure includes the aforementioned electrophotographic photoconductor, a charging unit, an exposing unit, a developing unit, and a transfer unit.

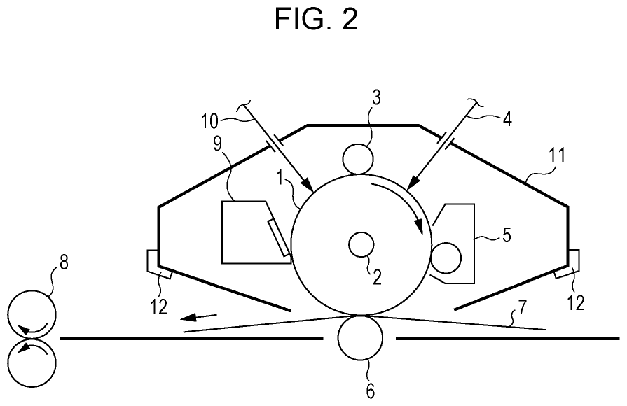

FIG. 2 illustrates a schematic structure of an electrophotographic apparatus that includes a process cartridge that includes an electrophotographic photoconductor and is detachably attached to an electrophotographic apparatus main body.

A cylindrical electrophotographic photoconductor 1 is driven and rotated about a shaft 2 in the arrow direction at a particular circumferential velocity. The surface of the electrophotographic photoconductor 1 is charged by a charging unit 3 to be at a particular plus or minus potential. In the drawing, a roller charging system that uses a roller-type charging member is illustrated; alternatively, other charging systems, such as a corona charging system, a proximity electrification system, and injection charging system, may be employed. The charged surface of the electrophotographic photoconductor 1 is irradiated with exposure light 4 from the exposing unit (not illustrated), and an electrostatic latent image corresponding to the desired image information is formed. The electrostatic latent image formed on the surface of the electrophotographic photoconductor 1 is developed with a toner stored in the developing unit 5, and a toner image is formed on the surface of the electrophotographic photoconductor 1. The toner image formed on the surface of the electrophotographic photoconductor 1 is transferred onto a transfer material 7 by the transfer unit 6. The transfer material 7 with a transferred toner image is conveyed to a fixing unit 8 to have the toner image fixed, and is discharged from the electrophotographic apparatus. The electrophotographic apparatus may include a cleaning unit 9 that removes attached matters, such as a toner remaining on the surface of the electrophotographic apparatus 1 after the transfer. Instead of providing a separate cleaning unit, a so-called cleaner-less system with which the attached matters are removed by a developing unit or the like may be employed. The electrophotographic apparatus may include a charge erasing mechanism that erases charges on the surface of the electrophotographic photoconductor 1 by using pre-exposure light 10 from a pre-exposure unit (not illustrated). In order to detach and attach the process cartridge of the present disclosure to the electrophotographic apparatus main body, a guiding unit 12, such as a rail, may be provided.

The electrophotographic photoconductor of the present disclosure can be used in a laser beam printer, an LED printer, a copying machine, a facsimile machine, a multifunction printer, or the like.

### EXAMPLES

The present disclosure will now be described in further detail through Examples and Comparative Examples below. The present invention is not limited by these examples as long as the examples are within the gist of the present invention. In the description of the examples below, “parts” is on a mass basis unless otherwise noted.

### Method for Producing Strontium Titanate Particles

### Production Example of Particles S-1

A titanium hydroxide-containing slurry obtained by hydrolyzing a titanyl sulfate aqueous solution was washed with an alkaline aqueous solution. Next, hydrochloric acid was added to the titanium hydroxide-containing slurry to adjust the pH to 0.7, and a titania sol dispersion was obtained as a result. To 2.2 mol (based on titanium oxide) of the titania sol dispersion, a strontium chloride aqueous solution in a molar amount 1.1 times that of the titania sol dispersion was added, the resulting mixture was placed in a reactor, and the reactor was purged with nitrogen gas. Furthermore, pure water was added so that so that the titanium oxide concentration was 1.1 mol/L. Next, the mixture was stirred, mixed, and heated to 90° C. To the resulting mixture, 440 mL of a 10N sodium hydroxide aqueous solution was added over 15 minutes while applying ultrasonic vibrations, and then the reaction was carried out for 20 minutes. Pure water at 5° C. was added to the slurry after the reaction, the resulting mixture was rapidly cooled to 30° C. or less, and the supernatant was removed. Furthermore, to the slurry, a hydrochloric acid aqueous solution having pH of 5.0 was added, and the resulting mixture was stirred for 1 hour and then repeatedly washed with pure water. Furthermore, the resulting slurry was neutralized with sodium hydroxide, filtered with a Nutsche filter, and washed with pure water. The obtained cake was dried, and particles S-1 were obtained.

### Production Example of Particle S-2

To 1.8 mol (based on titanium oxide) of the titania sol dispersion, a strontium chloride aqueous solution in a molar amount 1.1 times that of the titania sol dispersion was added, the resulting mixture was placed in a reactor, and the reactor was purged with nitrogen gas. Furthermore, pure water was added so that so that the titanium oxide concentration was 0.9 mol/L. Next, the mixture was stirred, mixed, and heated to 80° C. To the resulting mixture, 792 mL of a 5N sodium hydroxide aqueous solution was added for 40 minutes while applying ultrasonic vibrations, and then the reaction was carried out for 20 minutes. The slurry after the reaction was cooled to 30° C. or less, and then the supernatant was removed. Furthermore, to the slurry, a hydrochloric acid aqueous solution having a pH of 5.0 was added, and the resulting mixture was stirred for 1 hour and then repeatedly washed with pure water. Furthermore, the resulting slurry was neutralized with sodium hydroxide, filtered with a Nutsche filter, and washed with pure water. The obtained cake was dried, and particles S-2 were obtained.

### Production Example of Particles S-3

To 0.6 mol (based on titanium oxide) of the titania sol dispersion, a strontium chloride aqueous solution in a molar amount 1.2 times that of the titania sol dispersion was added, the resulting mixture was placed in a reactor, and the reactor was purged with nitrogen gas. Furthermore, 0.05 mol of aluminum sulfate was added, and then pure water was added so that so that the titanium oxide concentration was 0.3 mol/L. Next, the mixture was stirred, mixed, and heated to 80° C. To the resulting mixture, 450 mL of a 2N sodium hydroxide aqueous solution was added for 5 minutes while applying ultrasonic vibrations, and then the reaction was carried out for 20 minutes. Pure water at 5° C. was added to the slurry after the reaction, the resulting mixture was rapidly cooled to 30° C. or less, and the supernatant was removed. Furthermore, the slurry was washed with pure water, the obtained cake was dried, and particles S-3 were obtained.

### Measurement of Average Particle Diameter of Primary Particles

The average particle diameters (number average particle diameters) of the primary particles of the particles S-1 to S-3 prepared as above were determined by observing the primary particles with a transmission electron microscope “H-800” (produced by Hitachi, Ltd.) and measuring the long axes of one hundred primary particles in an enlarged view area magnified 2,000,000 fold at maximum. As a result, the average particle diameters of S-1, S-2, and S-3 were, respectively, 35 nm, 50 nm, and 110 nm.

### Production Example of Surface-Treated Strontium Titanate Particles

### Production Example of Surface-Treated Particles S-1A

One hundred parts of the particles S-1 produced as above and 500 parts of toluene were stirred and mixed, and thereto, 2 parts of N-2-(aminoethyl)-3-aminopropylmethyldimethoxysilane (trade name: KBM602 produced by Shin-Etsu Chemical Co., Ltd.) was added as a silane coupling agent, followed by stirring for 6 hours. Subsequently, toluene was distilled away, and the resulting residue was heated and dried at 130° C. for 6 hours. As a result, surface-treated particles S-1A were obtained.

### Production Examples of Surface-Treated Particles S-2A and S-3A

Surface-treated particles S-2A and S-3A were produced as in the production example of the surface-treated particles S-1A except that the particles S-1 were changed to the particles S-2 and S-3, respectively.

### Production Example of Surface-Treated Particles Z-1

One hundred parts of zinc oxide particles (BET specific surface area: 20 m²/g) serving as a substrate and 500 parts of toluene were stirred and mixed. Thereto, 0.50 parts of a silane coupling agent (compound name: N-2-(aminoethyl)-3-aminopropyltrimethoxysilane, trade name: KBM603 produced by Shin-Etsu Chemical Co., Ltd.) was added, followed by stirring for 6 hours. Subsequently, toluene was distilled away, and the resulting residue was heated and dried at 130° C. for 6 hours. As a result, surface-treated particles Z-1 were obtained.

### Example 1

An aluminum cylinder having a length of 357.5 mm, a thickness of 0.7 mm, and an outer diameter of 30 mm was prepared as a support (conductive support). The surface of aluminum cylinder was machined by using a lathe.

As the machining conditions, a bite with R of 0.1 was used, and machining was performed at a main shaft rotation speed of 10000 rpm while continuously changing the bite feed rate within the range of 0.03 to 0.06 mm/rpm.

Next, 14.5 parts of a butyral resin (trade name: BM-1, produced by Sekisui Chemical Company) serving as a polyol resin and 14.5 parts of a blocked isocyanate (trade name: Sumidur 3175 produced by Sumika Bayer Urethane Co., Ltd.) were dissolved in a mixed solution containing 300 parts of methyl ethyl ketone and 300 parts of 1-butanol.

To the resulting solution, 121 parts of the particles S-1A serving as strontium titanate particles and 1.21 parts of 2,3,4-trihydroxybenzophenone (produced by Tokyo Chemical Industry Co., Ltd.) serving as an additive were added, and the resulting mixture was dispersed in a sand mill apparatus using glass beads having a diameter of 0.8 mm in a 23±3° C. atmosphere for 3 hours.

After dispersing, 0.01 parts of a silicone oil (trade name: SH28PA produced by Dow Corning Toray Co., Ltd.) was added to the dispersion, followed by stirring. As a result, an undercoat layer coating solution was obtained.

The obtained undercoat layer coating solution was applied to the support by dip-coating, and the applied coating solution was dried at 160° C. for 30 minutes to form an undercoat layer having a thickness of 2.0 μm.

Into a sand mill containing glass beads having a diameter of 1 mm, 10 parts of a chlorogallium phthalocyanine pigment having diffraction peaks at Bragg angles (2θ±0.2°) of 7.4°, 16.6°, 25.5°, and 28.3° in an X-ray diffraction pattern obtained by using Cu K-α radiation, 10 parts of a V-type hydroxygallium phthalocyanine pigment, 10 parts of a polyvinyl butyral resin (trade name: S-LEC BX-1 produced by Sekisui Chemical Co., Ltd.), and 600 parts of cyclohexanone were placed, the resulting mixture was dispersed for 4 hours, and then 600 parts of ethyl acetate was added to the dispersion to prepare a charge generation layer coating solution.

The charge generation layer coating solution was applied to the undercoat layer by dip-coating, and the applied coating solution was dried at 80° C. for 15 minutes to form a charge generation layer having a thickness of 0.18 μm.

Next, 60 parts of a compound (charge transport material) represented by formula (A) below, 30 parts of a compound (charge transport material) represented by formula (B) below, 10 parts of a compound represented by formula (C) below, 100 parts of a polycarbonate resin (trade name: Iupilon Z400 produced by Mitsubishi Engineering-Plastics Corporation, bisphenol-Z polycarbonate), and 0.02 parts of a polycarbonate (viscosity average molecular weight Mv: 20,000) represented by formula (D) below were dissolved in a mixed solvent containing 600 parts of o-xylene and 200 of dimethoxymethane to prepare a charge transport layer coating solution.

The charge transport layer coating solution was applied to the charge generation layer by dip-coating to form a coating film, and the coating film was dried at 100° C. for 30 minutes to form a charge transport layer having a thickness of 18 μm.

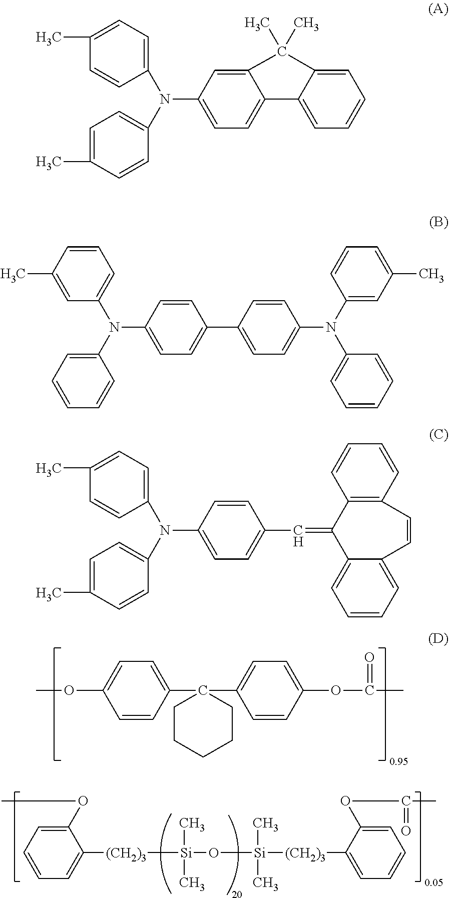

Next, 95 parts of a compound represented by formula (E) below, 5 parts of a vinyl ester compound (produced by Tokyo Chemical Industry Co., Ltd.), which is a compound represented by formula (F) below, 3.5 parts of a siloxane-modified acryl compound (trade name: BYK-3550 produced by BYK Japan KK), 5 parts of a urea compound represented by formula (G) below, 200 parts of 1-propanol, and 100 parts of 1,1,2,2,3,3,4-heptafluorocyclopentane (trade name: ZEORORA H, produced by Zeon Corporation) were mixed and stirred.

Subsequently, the resulting solution was filtered through a polyflon filter (trade name: PF-020 produced by Advantec Toyo Kaisha, Ltd.) to prepare a surface layer coating solution (protective layer coating solution).

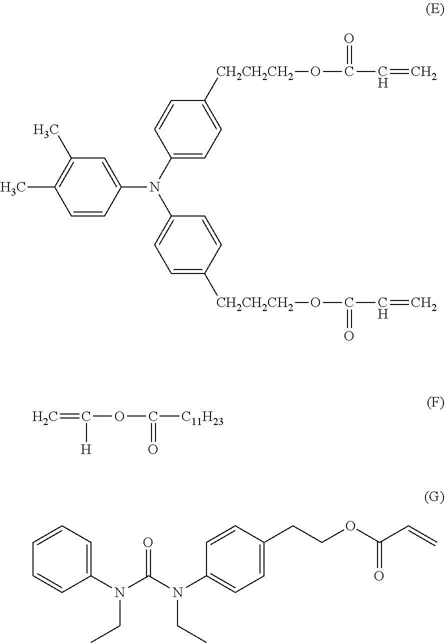

The surface layer coating solution was applied to the charge transport layer by dip-coating to form a coating film, and the coating film was dried at 50° C. for 10 minutes. Subsequently, in a nitrogen atmosphere, the coating film was exposed to an electron beam at an acceleration voltage of 70 kV and a beam current of 5.0 mA for 1.6 seconds while rotating the support (exposure subject) at a speed of 200 rpm. The electron beam absorbed dose during this process was measured and was 15 kGy. Then, in a nitrogen atmosphere, the coating film was heated such that the temperature of the coating film was elevated from 25° C. to 117° C. in 30 seconds. The oxygen concentration from the electron beam exposure to the subsequent heat treatment was 15 ppm or less. Next, in an air atmosphere, the coating film was naturally cooled until 25° C., and then the coating film was heat-treated for 30 minutes under the conditions that the temperature of the coating film reached 105° C. so as to form a protective layer (surface layer) having a thickness of 5 μm. Thus, an electrophotographic photoconductor before formation of recesses was prepared.

### Formation of Recesses by Pressure-Contact Profile Transfer Using Mold

Next, a molding member (mold) was loaded onto a pressure-contact profile transfer processing apparatus, and surface processing was performed on the obtained electrophotographic photoconductor before formation of recesses. Specifically, a mold generally illustrated in FIGS. 4A to 4C is loaded onto a pressure-contact profile transfer processing apparatus having a structure generally illustrated in FIG. 5, and surface processing was performed on the electrophotographic photoconductor before formation of the recesses. FIGS. 4A to 4C are diagrams illustrating a mold used in Examples and Comparative Examples. FIG. 4A is a schematic top view of the mold, and FIG. 4B is a schematic cross-sectional view of a protrusion of the mold taken in a direction of the axis of the electrophotographic photoconductor (cross-sectional view taken along line IVB-IVB in FIG. 4A). FIG. 4C is a cross-sectional view of a protrusion of the mold taken in the circumferential direction of the electrophotographic photoconductor (cross-sectional view taken along line IVC-IVC in FIG. 4A). The mold illustrated in FIGS. 4A to 4C had a protruding shape having a maximum width (maximum width in the axis direction of the electrophotographic photoconductor when the protrusion on the mold is viewed from above) X of 50 μm, a maximum length (maximum length in the circumferential direction of the electrophotographic photoconductor when the protrusion on the mold is viewed from above) Y of 75 μm, an area ratio of 56%, and a height H of 4 μm. The area ratio is the ratio of the area occupied by protrusions with respect to the entire surface when the mold is viewed from above. During processing, the temperatures of the electrophotographic photoconductor and the mold were controlled such that the temperature of the surface of the electrophotographic photoconductor was 120° C. Then, while the electrophotographic photoconductor and the pressing member were pressed against the mold at a pressure of 7.0 MPa, the electrophotographic photoconductor was rotated in the circumferential direction to form recesses throughout the entire surface layer (peripheral surface) of the electrophotographic photoconductor. Thus, an electrophotographic photoconductor of Example 1 was made.

### Evaluation of Electrophotographic Photoconductor

The electrical characteristics of the electrophotographic photoconductor were evaluated by using a cyan station of a modified model of image RUNNER ADVANCE C5560, which is an electrophotographic photoconductor produced by CANON KABUSHIKI KAISHA. The evaluation apparatus was put in a low-humidity environment having a temperature of 23° C. and a relative humidity of 5% RH. The surface potential of the electrophotographic photoconductor was measured by removing a developing cartridge from the evaluation apparatus, and inserting thereto a potential measuring apparatus. The potential measuring apparatus was configured by placing a potential measuring probe at a developing position of the developing cartridge, and the position of the potential measuring probe was set at the center of the electrophotographic photoconductor in the generatrix direction. The charging unit was a charging system that applied a DC voltage superimposed with 2000 Hz/1500 Vpp AC voltage to a roller-type contact charging member (charging roller). The voltage applied to the charging member (charging roller) was adjusted so that the dark potential Vd1 was −800 V, and then the laser light quantity was adjusted so that the light potential V11 was −300 V when the laser light having a wavelength of 780 nm was applied to expose the image. After Vd1 and V11 were adjusted as such, the potential measuring apparatus was removed from the main body, and a developing unit was attached to enable image output. First, a full-page cyan halftone image was output, and the roughness of the output image was evaluated with naked eye according to the following standard. Here, the rating C was unacceptable. The results are indicated in Table 1.

A: No roughness was found.

B: Slight roughness was found, but the level of the roughness does not pose any problem in actual use.
C: Extensive roughness was found, and the level of the roughness poses a problem in actual use.
Next, a paper feeding test involving transverse feeding of 100,000 sheets of A4 paper was performed. A transverse black band image having a printing ratio of 5% was used as the endurance image pattern. After the paper feeding test, the potential measuring apparatus was again installed in the evaluation machine, the dark potential Vd2 of the photoconductor after the endurance was measured, and the amount of change ΔVd in dark potential between before and after the endurance was determined according to the following equation.

ΔVd[−V]=Vd2[−V]−Vd1[−V]

The results are indicated in Table.

### Example 2

An electrophotographic photoconductor of Example 2 was prepared and evaluated as in Example 1 except that 121 parts of the strontium titanate particles S-1A used in Example 1 to be dispersed in the undercoat layer coating solution were changed to 121 parts of the particles S-2A. The results are indicated in Table 1.

### Example 3

An electrophotographic photoconductor of Example 3 was prepared and evaluated as in Example 1 except that 121 parts of the strontium titanate particles S-1A used in Example 1 to be dispersed in the undercoat layer coating solution were changed to 121 parts of the particles S-3A. The results are indicated in Table.

### Example 4

An electrophotographic photoconductor of Example 4 was prepared and evaluated as in Example 1 except that 1.21 parts of 2,3,4-trihydroxybenzophenone added to the undercoat layer coating solution in Example 1 was changed to 1.21 parts of alizarin (produced by Tokyo Chemical Industry Co., Ltd.). The results are indicated in Table 1.

### Example 5

An electrophotographic photoconductor of Example 5 was prepared and evaluated as in Example 2 except that 1.21 parts of 2,3,4-trihydroxybenzophenone added to the undercoat layer coating solution in Example 2 was changed to 1.21 parts of alizarin (produced by Tokyo Chemical Industry Co., Ltd.). The results are indicated in Table 1.

### Example 6

An electrophotographic photoconductor of Example 6 was prepared and evaluated as in Example 3 except that 1.21 parts of 2,3,4-trihydroxybenzophenone added to the undercoat layer coating solution in Example 3 was changed to 1.21 parts of alizarin (produced by Tokyo Chemical Industry Co., Ltd.). The results are indicated in Table 1.

### Example 7

The process up to and including formation of the undercoat layer was performed as in Example 1. Next, into a sand mill containing glass beads having a diameter of 1 mm, 22.5 parts of a chlorogallium phthalocyanine pigment having diffraction peaks at Bragg angles (2θ±0.2°) of 7.4°, 16.6°, 25.5°, and 28.3° in an X-ray diffraction pattern obtained by using Cu K-α radiation, 5 parts of a polyvinyl butyral resin (trade name: S-LEC BX-1 produced by Sekisui Chemical Co., Ltd.), and 600 parts of cyclohexanone were placed, the resulting mixture was dispersed for 4 hours, and then 600 parts of ethyl acetate was added to the dispersion to prepare a charge generation layer coating solution.

The charge generation layer coating solution was applied to the undercoat layer by dip-coating, and the applied coating solution was dried at 80° C. for 15 minutes to form a charge generation layer having a thickness of 0.18 μm.

Next, an electrophotographic photoconductor of Example 7 was prepared by performing formation of a charge transport layer, formation of a protective layer, and surface-processing as in Example 1, and evaluated as in Example 1. The results are indicated in Table 1.

### Example 8

An electrophotographic photoconductor of Example 8 was prepared and evaluated as in Example 7 except that 1.21 parts of 2,3,4-trihydroxybenzophenone added to the undercoat layer coating solution in Example 7 was changed to 1.21 parts of alizarin (produced by Tokyo Chemical Industry Co., Ltd.). The results are indicated in Table 1.

### Example 9

The process up to and including formation of the undercoat layer was performed as in Example 1. Next, into a sand mill containing glass beads having a diameter of 1 mm, 20 parts of a chlorogallium phthalocyanine pigment having diffraction peaks at Bragg angles (2θ±0.2°) of 7.4°, 16.6°, 25.5°, and 28.3° in an X-ray diffraction pattern obtained by using Cu K-α radiation, 5 parts of a polyvinyl butyral resin (trade name: S-LEC BX-1 produced by Sekisui Chemical Co., Ltd.), and 600 parts of cyclohexanone were placed, the resulting mixture was dispersed for 4 hours, and then 600 parts of ethyl acetate was added to the dispersion to prepare a charge generation layer coating solution.

The charge generation layer coating solution was applied to the undercoat layer by dip-coating, and the applied coating solution was dried at 80° C. for 15 minutes to form a charge generation layer having a thickness of 0.18 μm.

Next, an electrophotographic photoconductor of Example 9 was prepared by performing formation of a charge transport layer, formation of a protective layer, and surface-processing as in Example 1, and evaluated as in Example 1. The results are indicated in Table 1.

### Example 10

An electrophotographic photoconductor of Example 10 was prepared and evaluated as in Example 9 except that 1.21 parts of 2,3,4-trihydroxybenzophenone added to the undercoat layer coating solution in Example 9 was changed to 1.21 parts of alizarin (produced by Tokyo Chemical Industry Co., Ltd.). The results are indicated in Table 1.

### Example 11

The process up to and including formation of the undercoat layer was performed as in Example 1. Into a sand mill containing glass beads having a diameter of 1 mm, 6 parts of a chlorogallium phthalocyanine pigment having diffraction peaks at Bragg angles (2θ±0.2°) of 7.4°, 16.6°, 25.5°, and 28.3° in an X-ray diffraction pattern obtained by using Cu K-α radiation, 14 parts of a V-type hydroxygallium phthalocyanine pigment, 10 parts of a polyvinyl butyral resin (trade name: S-LEC BX-1 produced by Sekisui Chemical Co., Ltd.), and 600 parts of cyclohexanone were placed, the resulting mixture was dispersed for 4 hours, and then 600 parts of ethyl acetate was added to the dispersion to prepare a charge generation layer coating solution.

The charge generation layer coating solution was applied to the undercoat layer by dip-coating, and the applied coating solution was dried at 80° C. for 15 minutes to form a charge generation layer having a thickness of 0.18 μm. Next, an electrophotographic photoconductor of Example 11 was prepared by performing formation of a charge transport layer, formation of a protective layer, and surface-processing as in Example 1, and evaluated as in Example 1. The results are indicated in Table 1.

### Example 12

An electrophotographic photoconductor of Example 12 was prepared and evaluated as in Example 11 except that 1.21 parts of 2,3,4-trihydroxybenzophenone added to the undercoat layer coating solution in Example 11 was changed to 1.21 parts of alizarin (produced by Tokyo Chemical Industry Co., Ltd.). The results are indicated in Table 1.

### Example 13

The process up to and including formation of the undercoat layer was performed as in Example 1. Into a sand mill containing glass beads having a diameter of 1 mm, 3 parts of a chlorogallium phthalocyanine pigment having diffraction peaks at Bragg angles (2θ±0.2°) of 7.4°, 16.6°, 25.5°, and 28.3° in an X-ray diffraction pattern obtained by using Cu K-α radiation, 17 parts of a V-type hydroxygallium phthalocyanine pigment, 10 parts of a polyvinyl butyral resin (trade name: S-LEC BX-1 produced by Sekisui Chemical Co., Ltd.), and 600 parts of cyclohexanone were placed, the resulting mixture was dispersed for 4 hours, and then 600 parts of ethyl acetate was added to the dispersion to prepare a charge generation layer coating solution.

The charge generation layer coating solution was applied to the undercoat layer by dip-coating, and the applied coating solution was dried at 80° C. for 15 minutes to form a charge generation layer having a thickness of 0.18 μm. Next, an electrophotographic photoconductor of Example 13 was prepared by performing formation of a charge transport layer, formation of a protective layer, and surface-processing as in Example 1, and evaluated as in Example 1. The results are indicated in Table. 1

### Example 14

An electrophotographic photoconductor of Example 14 was prepared and evaluated as in Example 13 except that 1.21 parts of 2,3,4-trihydroxybenzophenone added to the undercoat layer coating solution in Example 13 was changed to 1.21 parts of alizarin (produced by Tokyo Chemical Industry Co., Ltd.). The results are indicated in Table 1.

### Example 15

A support was prepared as in Example 1. Next, 5.5 parts of a butyral resin (trade name: BM-1, produced by Sekisui Chemical Company) serving as a polyol resin and 5.5 parts of a blocked isocyanate (trade name: Sumidur 3175 produced by Sumika Bayer Urethane Co., Ltd.) were dissolved in a mixed solution containing 300 parts of methyl ethyl ketone and 300 parts of 1-butanol. To the resulting solution, 139 parts of the particles S-1A serving as strontium titanate particles and 1.39 parts of 2,3,4-trihydroxybenzophenone (produced by Tokyo Chemical Industry Co., Ltd.) serving as an additive were added, and the resulting mixture was dispersed in a sand mill apparatus using glass beads having a diameter of 0.8 mm in a 23±3° C. atmosphere for 3 hours. After dispersing, 0.01 parts of a silicone oil (trade name: SH28PA produced by Dow Corning Toray Co., Ltd.) was added to the dispersion, followed by stirring. As a result, an undercoat layer coating solution was obtained. The obtained undercoat layer coating solution was applied to the support by dip-coating, and the applied coating solution was dried at 160° C. for 30 minutes to form an undercoat layer having a thickness of 2.0 μm. Next, an electrophotographic photoconductor of Example 15 was prepared by performing formation of a charge generation layer, formation of a charge transport layer, formation of a protective layer, and surface-processing as in Example 1, and evaluated as in Example 1. The results are indicated in Table 1.

### Example 16

An electrophotographic photoconductor of Example 16 was prepared and evaluated as in Example 15 except that 1.39 parts of 2,3,4-trihydroxybenzophenone added to the undercoat layer coating solution in Example 15 was changed to 1.39 parts of alizarin (produced by Tokyo Chemical Industry Co., Ltd.). The results are indicated in Table 1.

### Example 17

A support was prepared as in Example 1. Next, 7 parts of a butyral resin (trade name: BM-1, produced by Sekisui Chemical Company) serving as a polyol resin and 7 parts of a blocked isocyanate (trade name: Sumidur 3175 produced by Sumika Bayer Urethane Co., Ltd.) were dissolved in a mixed solution containing 300 parts of methyl ethyl ketone and 300 parts of 1-butanol. To the resulting solution, 136 parts of the particles S-1A serving as strontium titanate particles and 1.36 parts of 2,3,4-trihydroxybenzophenone (produced by Tokyo Chemical Industry Co., Ltd.) serving as an additive were added, and the resulting mixture was dispersed in a sand mill apparatus using glass beads having a diameter of 0.8 mm in a 23±3° C. atmosphere for 3 hours. After dispersing, 0.01 parts of a silicone oil (trade name: SH28PA produced by Dow Corning Toray Co., Ltd.) was added to the dispersion, followed by stirring. As a result, an undercoat layer coating solution was obtained. The obtained undercoat layer coating solution was applied to the support by dip-coating, and the applied coating solution was dried at 160° C. for 30 minutes to form an undercoat layer having a thickness of 2.0 μm. Next, an electrophotographic photoconductor of Example 17 was prepared by performing formation of a charge generation layer, formation of a charge transport layer, formation of a protective layer, and surface-processing as in Example 1, and evaluated as in Example 1. The results are indicated in Table 1.

### Example 18

An electrophotographic photoconductor of Example 18 was prepared and evaluated as in Example 17 except that 1.36 parts of 2,3,4-trihydroxybenzophenone added to the undercoat layer coating solution in Example 17 was changed to 1.36 parts of alizarin (produced by Tokyo Chemical Industry Co., Ltd.). The results are indicated in Table 1.

### Example 19

A support was prepared as in Example 1. Next, 14.5 parts of a butyral resin (trade name: BM-1, produced by Sekisui Chemical Company) serving as a polyol resin and 14.5 parts of a blocked isocyanate (trade name: Sumidur 3175 produced by Sumika Bayer Urethane Co., Ltd.) were dissolved in a mixed solution containing 300 parts of methyl ethyl ketone and 300 parts of 1-butanol. To the resulting solution, 76 parts of the particles S-1A serving as strontium titanate particles, 45 parts of the surface-treated zinc oxide particles Z-1, and 1.21 parts of 2,3,4-trihydroxybenzophenone (produced by Tokyo Chemical Industry Co., Ltd.) serving as an additive were added, and the resulting mixture was dispersed in a sand mill apparatus using glass beads having a diameter of 0.8 mm in a 23±3° C. atmosphere for 3 hours. After dispersing, 0.01 parts of a silicone oil (trade name: SH28PA produced by Dow Corning Toray Co., Ltd.) was added to the dispersion, followed by stirring. As a result, an undercoat layer coating solution was obtained. The obtained undercoat layer coating solution was applied to the support by dip-coating, and the applied coating solution was dried at 160° C. for 30 minutes to form an undercoat layer having a thickness of 2.0 μm. Next, an electrophotographic photoconductor of Example 19 was prepared by performing formation of a charge generation layer, formation of a charge transport layer, formation of a protective layer, and surface-processing as in Example 1, and evaluated as in Example 1. The results are indicated in Table 1.

### Example 20

An electrophotographic photoconductor of Example 20 was prepared and evaluated as in Example 19 except that 1.21 parts of 2,3,4-trihydroxybenzophenone added to the undercoat layer coating solution in Example 19 was changed to 1.21 parts of alizarin (produced by Tokyo Chemical Industry Co., Ltd.). The results are indicated in Table 1.

### Example 21

A support was prepared as in Example 1. Next, 14.5 parts of a butyral resin (trade name: BM-1, produced by Sekisui Chemical Company) serving as a polyol resin and 14.5 parts of a blocked isocyanate (trade name: Sumidur 3175 produced by Sumika Bayer Urethane Co., Ltd.) were dissolved in a mixed solution containing 300 parts of methyl ethyl ketone and 300 parts of 1-butanol. To the resulting solution, 61 parts of the particles S-1A serving as strontium titanate particles, 60 parts of the surface-treated zinc oxide particles Z-1, and 1.21 parts of 2,3,4-trihydroxybenzophenone (produced by Tokyo Chemical Industry Co., Ltd.) serving as an additive were added, and the resulting mixture was dispersed in a sand mill apparatus using glass beads having a diameter of 0.8 mm in a 23±3° C. atmosphere for 3 hours. After dispersing, 0.01 parts of a silicone oil (trade name: SH28PA produced by Dow Corning Toray Co., Ltd.) was added to the dispersion, followed by stirring. As a result, an undercoat layer coating solution was obtained. The obtained undercoat layer coating solution was applied to the support by dip-coating, and the applied coating solution was dried at 160° C. for 30 minutes to form an undercoat layer having a thickness of 2.0 μm. Next, an electrophotographic photoconductor of Example 21 was prepared by performing formation of a charge generation layer, formation of a charge transport layer, formation of a protective layer, and surface-processing as in Example 1, and evaluated as in Example 1. The results are indicated in Table 1.

### Example 22

An electrophotographic photoconductor of Example 22 was prepared and evaluated as in Example 21 except that 1.21 parts of 2,3,4-trihydroxybenzophenone added to the undercoat layer coating solution in Example 21 was changed to 1.21 parts of alizarin (produced by Tokyo Chemical Industry Co., Ltd.). The results are indicated in Table 1.

### Example 23

An electrophotographic photoconductor of Example 23 was prepared and evaluated as in Example 1 except that, in preparing the undercoat layer coating solution, 2,3,4-trihydroxybenzophenone used in Example 1 was not added. The results are indicated in Table 1.

### Example 24

The process up to and including formation of the undercoat layer was performed as in Example 1.
Into a sand mill containing glass beads having a diameter of 1 mm, 10 parts of a chlorogallium phthalocyanine pigment having diffraction peaks at Bragg angles (2θ±0.2°) of 7.4°, 16.6°, 25.5°, and 28.3° in an X-ray diffraction pattern obtained by using Cu K-α radiation,
10 parts of a titanyl phthalocyanine pigment having a maximum diffraction peak at a Bragg angle (2θ±0.2°) of 27.3° in an X-ray diffraction pattern obtained by using Cu K-α radiation,
10 parts of a polyvinyl butyral resin (trade name: S-LEC BX-1 produced by Sekisui Chemical Co., Ltd.), and
600 parts of cyclohexanone were placed,
the resulting mixture was dispersed for 4 hours, and then 600 parts of ethyl acetate was added to the dispersion to prepare a charge generation layer coating solution.
The charge generation layer coating solution was applied to the undercoat layer by dip-coating, and the applied coating solution was dried at 80° C. for 15 minutes to form a charge generation layer having a thickness of 0.18 μm.
Subsequently, an electrophotographic photoconductor of Example 24 was prepared by performing formation of a charge generation layer, formation of a charge transport layer, formation of a protective layer, and surface-processing as in Example 1, and evaluated as in Example 1. The results are indicated in Table 1.

### Comparative Example 1

A support was prepared as in Example 1. Next, 15 parts of a butyral resin (trade name: BM-1, produced by Sekisui Chemical Company) serving as a polyol resin and 15 parts of a blocked isocyanate (trade name: Sumidur 3175 produced by Sumika Bayer Urethane Co., Ltd.) were dissolved in a mixed solution containing 65 parts of methyl ethyl ketone and 65 parts of 1-butanol. To the resulting solution, 81 parts of the surface-treated zinc oxide particles Z-1 and 0.81 parts of 2,3,4-trihydroxybenzophenone (produced by Tokyo Chemical Industry Co., Ltd.) serving as an additive were added, and the resulting mixture was dispersed in a sand mill apparatus using glass beads having a diameter of 0.8 mm in a 23±3° C. atmosphere for 3 hours. After dispersing, 0.01 parts of a silicone oil (trade name: SH28PA produced by Dow Corning Toray Co., Ltd.) and 5.6 parts of crosslinked polymethyl methacrylate (PMMA) particles (trade name: TECHPOLYMER SSX-102 produced by Sekisui Plastics Co., Ltd., average primary particle diameter: 2.5 μm) were added to the dispersion, followed by stirring. As a result, an undercoat layer coating solution was obtained. The obtained undercoat layer coating solution was applied to the support by dip-coating, and the applied coating solution was dried at 160° C. for 40 minutes to form an undercoat layer having a thickness of 30 μm. Next, an electrophotographic photoconductor of Comparative Example 1 was prepared by performing formation of a charge generation layer, formation of a charge transport layer, formation of a protective layer, and surface-processing as in Example 1, and evaluated as in Example 1. The results are indicated in Table.

### Comparative Example 2

The process up to and including formation of the undercoat layer was performed as in Example 1. Next, into a sand mill containing glass beads having a diameter of 1 mm, 15 parts of a titanyl phthalocyanine pigment having a maximum diffraction peak at a Bragg angle (2θ±0.2°) of 27.3° in an X-ray diffraction pattern obtained by using Cu K-α radiation, 10 parts of a polyvinyl butyral resin (trade name: S-LEC BX-1 produced by Sekisui Chemical Co., Ltd.), and 600 parts of cyclohexanone were placed, the resulting mixture was dispersed for 4 hours, and then 600 parts of ethyl acetate was added to the dispersion to prepare a charge generation layer coating solution. The charge generation layer coating solution was applied to the undercoat layer by dip-coating, and the applied coating solution was dried at 80° C. for 15 minutes to form a charge generation layer having a thickness of 0.18 μm. Next, an electrophotographic photoconductor of Comparative Example 2 was prepared by performing formation of a charge transport layer, formation of a protective layer, and surface-processing as in Example 1, and evaluated as in Example 1. The results are indicated in Table.

TABLE

| | Undercoat layer | | | | | | | | |
|---|---|---|---|---|---|---|---|---|---|
| | | | Strontium | | | | | | |
| | | | titanate | | Charge generation layer | | | Evaluation | |
| | | | particle | | | | ClGaPc | results | |
| | Type of | | content | Type of | Type of charge | | content | Roughness | ΔVd |
| Example No. | particles | | [mass %] | additive | generation material | | [mass %] | level | [−V] |
| Example 1 | S-1A | — | 80 | A | ClGaPc | HOGaPc | 33 | A | −10 |
| Example 2 | S-2A | — | 80 | A | ClGaPc | HOGaPc | 33 | A | −12 |
| Example 3 | S-3A | — | 80 | A | ClGaPc | HOGaPc | 33 | A | 10 |
| Example 4 | S-1A | — | 80 | B | ClGaPc | HOGaPc | 33 | A | −10 |
| Example 5 | S-2A | — | 80 | B | ClGaPc | HOGaPc | 33 | A | −12 |
| Example 6 | S-3A | — | 80 | B | ClGaPc | HOGaPc | 33 | A | 10 |
| Example 7 | S-1A | — | 80 | A | ClGaPc | — | 82 | B | −13 |
| Example 8 | S-1A | — | 80 | B | ClGaPc | — | 82 | B | −13 |
| Example 9 | S-1A | — | 80 | A | ClGaPc | — | 80 | A | −13 |
| Example 10 | S-1A | — | 80 | B | ClGaPc | — | 80 | A | −13 |
| Example 11 | S-1A | — | 80 | A | ClGaPc | HOGaPc | 20 | A | −10 |
| Example 12 | S-1A | — | 80 | B | ClGaPc | HOGaPc | 20 | A | −10 |
| Example 13 | S-1A | — | 80 | A | ClGaPc | HOGaPc | 10 | A | −11 |
| Example 14 | S-1A | — | 80 | B | ClGaPc | HOGaPc | 10 | A | −11 |
| Example 15 | S-1A | — | 92 | A | ClGaPc | HOGaPc | 33 | B | −16 |
| Example 16 | S-1A | — | 92 | B | ClGaPc | HOGaPc | 33 | B | −16 |
| Example 17 | S-1A | — | 90 | A | ClGaPc | HOGaPc | 33 | A | −15 |
| Example 18 | S-1A | — | 90 | B | ClGaPc | HOGaPc | 33 | A | −15 |
| Example 19 | S-1A | Z-1 | 50 | A | ClGaPc | HOGaPc | 33 | A | −15 |
| Example 20 | S-1A | Z-1 | 50 | B | ClGaPc | HOGaPc | 33 | A | −15 |
| Example 21 | S-1A | Z-1 | 40 | A | ClGaPc | HOGaPc | 33 | A | −16 |
| Example 22 | S-1A | Z-1 | 40 | B | ClGaPc | HOGaPc | 33 | A | −16 |
| Example 23 | S-1A | — | 80 | — | ClGaPc | HOGaPc | 33 | A | 18 |
| Example 24 | S-1A | — | 80 | A | ClGaPc | TiOPc | 33 | A | −20 |
| Comparative | — | Z-1 | 0 | — | ClGaPc | HOGaPc | 33 | A | −50 |
| Example 1 | | | | | | | | | |
| Comparative | S-1A | — | 80 | — | TiOPc | — | 0 | A | −35 |
| Example 2 | | | | | | | | | |

In Table, “A” in the column indicating the additive in the undercoat layer represents 2,3,4-trihydroxybenzophenone, and “B” represents alizarin. The abbreviations used in Table are as follows: ClGaPc: chlorogallium phthalocyanine pigment, HOGaPc: hydroxygallium phthalocyanine pigment, TiOPc: titanyl phthalocyanine pigment.

The present disclosure can provide an electrophotographic photoconductor in which changes in charging potential are suppressed even when the electrophotographic photoconductor is repeatedly used in a low-humidity environment for a long term. Furthermore, a process cartridge and an electrophotographic apparatus that use such an electrophotographic photoconductor can also be provided.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-201213 filed Oct. 25, 2018 and No. 2019-180287 filed Sep. 30, 2019, which are hereby incorporated by reference herein in their entirety.

What is claimed is:

1. An electrophotographic photoconductor comprising, in sequence:
a support;
an undercoat layer;
a charge generation layer containing a charge generation material and a first binder resin; and
a charge transport layer containing a charge transport material and a second binder resin,
wherein the charge generation material is chlorogallium phthalocyanine having diffraction peaks at Bragg angles (2θ±0.2°) of 7.4°, 16.6°, 25.5°, and 28.3° in an X-ray diffraction pattern obtained by using Cu K-α radiation, and
the undercoat layer contains strontium titanate particles and a third binder resin.

2. The electrophotographic photoconductor according to claim 1, wherein a content of the strontium titanate particles relative to a total mass of the undercoat layer is 50 mass % or more and 90 mass % or less.

3. The electrophotographic photoconductor according to claim 1, wherein the charge generation layer further contains V-type hydroxygallium phthalocyanine.

4. The electrophotographic photoconductor according to claim 1, wherein a content of the chlorogallium phthalocyanine relative to a total mass of the charge generation layer is 20 mass % or more and 80 mass % or less.

5. The electrophotographic photoconductor according to claim 1, wherein the undercoat layer contains at least one compound selected from the group consisting of compounds represented by formula (1) and formula (2): 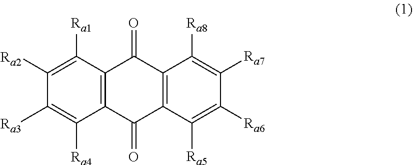
in formula (1), Rₐ₁ to Rₐ₈ each independently represent a hydrogen atom, a hydroxy group, a halogen atom, an alkyl group, an alkoxy group, a phenyl group, or an amino group, 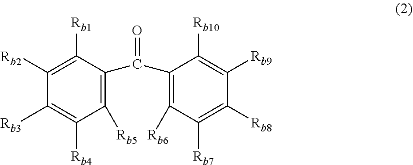
in formula (2), R_{b1} to R_{b10} each independently represent a hydrogen atom, a hydroxy group, a halogen atom, an alkyl group, an alkoxy group, a phenyl group, or an amino group.

6. A process cartridge detachably attachable to an electrophotographic apparatus main body, the process cartridge comprising:
an electrophotographic photoconductor including, in sequence, a support, an undercoat layer, a charge generation layer containing a charge generation material and a first binder resin, and a charge transport layer containing a charge transport material and a second binder resin, wherein the charge generation material is chlorogallium phthalocyanine having diffraction peaks at Bragg angles (2θ±0.2°) of 7.4°, 16.6°, 25.5°, and 28.3° in an X-ray diffraction pattern obtained by using a Cu K-α radiation, and the undercoat layer contains strontium titanate particles and a third binder resin; and
at least one unit selected from the group consisting of a charging unit, a developing unit, a transfer unit, a charge erasing unit, and a cleaning unit,
wherein the process cartridge integrates and supports the electrophotographic photoconductor and the at least one unit.

7. An electrophotographic apparatus comprising:
an electrophotographic photoconductor including, in sequence, a support, an undercoat layer, a charge generation layer containing a charge generation material and a first binder resin, and a charge transport layer containing a charge transport material and a second binder resin, wherein the charge generation material is chlorogallium phthalocyanine having diffraction peaks at Bragg angles (2θ±0.2°) of 7.4°, 16.6°, 25.5°, and 28.3° in an X-ray diffraction pattern obtained by using Cu K-α radiation, and the undercoat layer contains strontium titanate particles and a third binder resin;
a charging unit;
an exposing unit;
a developing unit; and
a transfer unit.
